(19) United States
(12) Patent Application Publication
(10) Pub. No.: US 2010/0218255 A1
(43) Pub. Date: Aug. 26, 2010

(54) Procedure for the 100% infection free installation/re-installation, patching and maintenance of a personal computers operating system

(76) Inventors: Keith Adam Ritman, Imperial, CA (US); Jennifer Kay Welsh, Imperial, CA (US)

Correspondence Address: Keith Adam Ritman, 590 W Brewer Road, Imperial, CA, 92251, US

(21) Appl. No.: 12/380,253

(22) Filed: Feb. 24, 2009

(51) Int. Cl. G06F 21/00; G06F 12/14; G06F 9/445

(52) U.S. Cl. 726/24; 717/176

(57) ABSTRACT

The procedure resolves the several well known and documented issues regarding installing, patching and securing a Personal Computer from the Internet threats that lead to the malfunctioning of the PC as well as Identity theft. The procedure includes the installing of the Operating System so it is 100% free of all of types of malicious computer attacks; Keeping the PC from being infected/re-infected during the required security patches and updates, Keeping the PC safe and in optimal condition for the life of the machine which is much longer than the industry standard 2-6 months.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention pertains to the unique field of Personal Computer Internet Security or a Technology Based Procedure.

This procedure was developed to overcome several known and well documented issues with the installing or reinstalling the Operating System of a Personal Computer without said Personal Computer becoming compromised before the installation is completed and during the critical updates and service packs which must be performed before the Personal Computer can be considered safe for internet use.

The first issue resolved by this procedure is that of installing the Operating System of the Personal Computer while keeping said Operating System 100% free of all of types of malicious computer attacks.

The second issue resolved by this procedure is that the Personal Computer is kept from being infected/re-infected by all types of malicious computer attacks while the Personal Computer is patched and update. These updates and patches can take a minimum of an hour to properly perform and intensive research uncovered hard evidence that the average time an un-patched/unprotected Personal Computer on the internet lasts before it is compromised by malicious software was within an average of 16 minutes as per noted and recognized authorities in the field of internet threats.

The third issue resolved by this procedure is that of keeping the Personal Computer safe from the myriad of malicious software attacks and keep the Personal Computer running in optimal condition for longer than the industry standard 2-6 months without having to continuously re-repair the machine.

### BRIEF SUMMARY OF THE INVENTION

By performing the step-by-step procedure laid out herein almost anyone with minimal computer knowledge can eradicate 100% of every type of Personal Computer security threat, malicious software or hacker attack; retain and clean a minimum of 97% of the personal sentimental and/or sensitive data contained on the Personal Computer; protect from re-infection while overcoming the malicious software that barrages a Personal Computer constantly and protect personal, sensitive and/or sentimental data from those who would use it for no good; while keeping the Personal computer running in optimal condition for longer than the industry standard 2-6 months without a retreatment.

### BRIEF DESCRIPTION OF THE SEVERAL VIEWS OF THE DRAWING

“Not Applicable”

### DETAILED DESCRIPTION OF THE INVENTION

### A Procedure for the 100% Infection Free Installation/Re-Installation and Patching of a Personal Computers Operating System.

I. Hook up PC on bench or in location it is to be used in
   A. Connect ONLY: Keyboard, mouse, monitor and Power cable
   B. Ensure that the Network card is non-functional by NOT connecting the LAN cable.
   C. Ensure that there are 0 active wireless connections by removing any external wireless devices or disabling any internal devices if possible.
II. Boot the computer into the BIOS or Set-Up feature
   A. Look for a prompt that says press [F#] to enter set-up
      1. Ensure that the time and date in the BIOS are correct
      2. Ensure that S.M.A.R.T. is enabled if available
      3. Ensure that the PC boots from the CD drive first at this time
      4. Ensure that the AGP aperture if settable is set to ½ the amount of the available RAM the PC is equipped with.
      5. Ensure that the PC does NOT boot from other devices or the LAN
      6. Ensure that the on-board video (if so equipped) is set to ½ the AGP aperture if possible or its' highest setting if not
      7. Ensure that 32-bit transfers and DMA are enabled on the hard drive and the CD drives if applicable.
   B. Save settings and exit BIOS
III. Start the PC in the Operating systems Safe or diagnostic mode
   A. Skip this entire step if you are not backing up any data
      1. Press [F8] until you see the advanced start up menu
      2. Highlight and select safe mode
      3. Press [enter]
   B. Locate and Back up all user data
      1. Backing up data simply means copying or moving the data from the PC to an external device. (Any external storage device will suffice as long as it has enough space to store all the data to be saved)
      2. DO NOT attempt to burn a CD or DVD of the data, it will in most cases NOT work
      3. Remove external storage device
      4. Place Operating Systems boot CD/DVD into the CD/DVD drive
      5. Shut off PC
IV. Boot PC into Operating Systems Set-up or Install mode.
   A. Look for a prompt that states “Press ANY key to boot from CD . . . . ”
   B. Press the [space] bar one time before 5 “.” Appear, the installation will begin
   C. Agree to any licensing or EULA's and stop when you reach the point of viewing the partitions on the hard drive.
V. Partition the Hard Disk Drive
   A. If this is a Re-installation due to non-compliance and the users data is already on the D or other drive letter skip to step 5-B.
      1. Delete ALL existing partitions
         a. If the PC crashes, hangs, errors or reports that it cannot find a hard drive refer to instructions on installing a NON recognized SaTa or ScSi hard drive (not included in this procedure)
         b. If the PC crashes, hangs or errors but does not have a SaTa or ScSi hard drive restart the procedure from step 4 and watch for a prompt that states “Press [F6] if you need to install a non recognized device, do NOT press [F6] at this time but press [F7] instead
      2. Create 2 separate partitions
         a. for Hard drives smaller than 40 Gb create only 1
         b. For hard drives larger than 100 GB create one 50 GB and a second with the remaining space.
         c. For hard drives between 40 and 100 Gb create 2 even partitions
   B. Format the first (C:) Hard drive using FULL Format mode ONLY
      1. NEVER use a quick format
      2. Never Format the second partition at this time
VI. Allow The Operating System Installation To Run
   A. Answer any interactive dialogs with generic answers (i.e. if asked for a user answer user, if it asks you to create new users name create 2 and name them “user 0-1” and “user 0-2”)
   B. Skip any steps that refer to network set up during the installation or do not allow them
   C. Complete the OS installation and boot the PC to the OS for the first time.
VII. Enter the USER 0-1 account (or the Administrator Account if no users were created in step 6-A)
   A. Enter the Device Manager
      1. Make a note of any devices that are not installed properly
         a. If the Network adapter is not installed or the wireless adapter is not installed, you must search/provide them at this time (generally the manufacturers support website will have a downloads section)
         b. Locate and install the Network or Wireless adapter but do not connect at this time
      2. Begin the installation of a Full security suite
         a. Suite must have
            i. Antivirus (not one of the top 5 sellers)
            ii. Firewall (Do not use windows firewall)
            iii. Anti-Spyware
            iv. Anti-Malware
            v. Website-Inspector
            vi. Parental Controls (if required)
            vii. Ad-ware remover
      3. Connect LAN cable ONLY at this time
         a. Allow the security suite to perform any updates and restart the PC
         b. If asked about setting the network type (home, Public, safe, restricted)
            i. If on a home wireless or wired router You are safe or HOME
            ii. If on a public café network or PC is connected directly to the modem you are PRIVATE or RESTRICTED
VIII. Perform OS Critical updates and service packs (CUSP)
   A. Go to the Operating System's Manufacturers website
      1. Perform all available service packs
      2. Perform all required/optional/hardware updates
IX. Locate and install any hardware drivers that are not automatically found
   A. Go to the Manufacturers website for the PC or Main board
   B. Install order (if device is not installed yet available)
      1. Chipset
      2. Processor Driver
      3. Video Driver
      4. Sound Driver
      5. Any other devices
X. Move all major folders to the second partition
   A. Create new folders on second partition
      1. One folder for each user (User 0-1, User 0-2)
   B. Move all 3 folders for each user
      1. Desktop
      2. Documents
      3. Favorites
   C. Each user must have logged in once for their folders to be created, then you can move them.

1. Allow almost any one with minimal computer literacy to eradicate 100% of all types of malicious Personal Computer attacks and infections during the installation or re-installation of said Personal Computer's Operating System.

2. Block all attacks and attempts at infection or re-infection during the critical updates and service packs that are required to be installed before the Personal Computer can be considered safe for use on the internet.

3. Retain and clean 99% of said Personal Computers sensitive, sentimental and or private data.

4. Prevent 99% of the possibility of Identity Theft from said PC.

5. Educate the end user(s) on the minimal maintenance that is required to sustain optimal, infection free, performance for the life of the computer and the risks involved with having the internet and Identity Theft.
